(19) United States
(12) Patent Application Publication
(10) Pub. No.: US 2008/0301270 A1
(43) Pub. Date: Dec. 4, 2008

(54) SYSTEM AND METHOD FOR DIRECTED PROVISION AND INSTALLATION OF DEVICE-SPECIFIC FUNCTIONALITIES, IN PARTICULAR FOR FIELD DEVICES

(75) Inventor: Dirk JOHN, Karlsruhe (DE)

Correspondence Address: BUCHANAN, INGERSOLL & ROONEY PC, POST OFFICE BOX 1404, ALEXANDRIA, VA, 22313-1404, US

(73) Assignee: ABB AG, Mannheim (DE)

(21) Appl. No.: 12/129,971

(22) Filed: May 30, 2008

(30) Foreign Application Priority Data
Jun. 1, 2007 (DE) 10 2007 025 657.6
Feb. 21, 2008 (DE) 10 2008 010 484.1

(51) Int. Cl. G06F 15/177

(52) U.S. Cl. 709/221

(57) ABSTRACT

A method for directed provision and installation of device-specific functionalities and/or information for field devices which are arranged in a distributed system, in particular in a distributed automation system, wherein in a first step, a field device to be connected to the system is supplied with basic functionalities and/or basic information for operation of the field device in the system, bypassing a higher-level controller for the system, after which in a second step, the higher-level controller automatically installs further required upgrade functionalities and/or upgrade information in order to produce the full functional scope of the field device, using the existing basic functionalities and/or basic information.

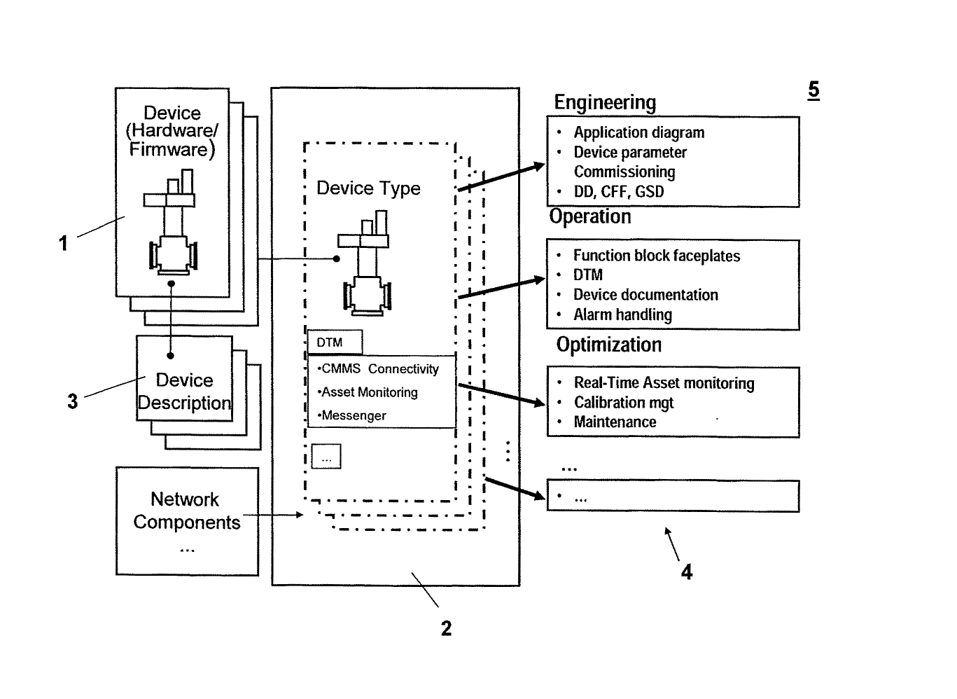

### RELATED APPLICATIONS

This application claims priority under 35 U.S.C. §119 to German Patent Application No. 10 2007 025 657.6 filed in Germany on Jun. 1, 2007 and German Patent Application No. 10 2008 010 484.1 filed in Germany on Feb. 21, 2008, the entire contents of which are hereby incorporated by reference in their entireties.

### TECHNICAL FIELD

The present disclosure relates to a system and a method for directed provision and installation of device-specific functionalities and/or information for field devices which are arranged in a distributed system, in particular in a distributed automation system.

### BACKGROUND INFORMATION

The structure of a distributed system comprises a multiplicity of field devices which communicate via a network structure, for example using a bus system, with one another and/or with a higher-level control system or controller. Examples of field devices which are used in distributed systems such as these are drives, motor protection units, switchgear assemblies, sensors, in particular sensors for pressure, temperature, and flow measurements, low-voltage devices, actuators and/or analysis devices.

Device information such as device documentation, main device data and device parameters, is or are stored for the field devices in the distributed system.

The functions of the field devices are not just restricted to passing on measurement data or fault reports. The field devices are increasingly being updated with additional functionalities for configuration and diagnosis of an automation system, for example with control functions, commissioning functions, diagnosis functions, maintenance functions, optimization functions, alarm processing functions and/or life functions, in which case the additional functionalities must also be integrated separately in each field device.

A multiplicity of applications for control, for preventative maintenance and for status recording of the distributed system, which are also known as asset optimization (installation optimization) are closely related to the field devices, and must be installed for the field devices.

In order to provide the functionality and all of the descriptions relating to it which are accessed by the field device in the distributed system over the entire life cycle, complex installation and configuration processes are required for the device-specific functionalities and/or information for the field devices, since the device-specific functionalities and/or information must be provided separately and must be transmitted to the distributed system for each field device.

Furthermore, it has been found to be disadvantageous that the device-specific functionalities and/or information for the field devices and the associated components must be integrated individually in the distributed system. This process is highly time consuming and is associated with a large amount of technical complexity, in particular considerably increasing the commissioning effort.

Components which are necessary in order to address an appropriate field device and to use in a given network do not yet exist by means of the procedure described above, but involve further configuration and commissioning steps. These components differ depending on the available communication architecture. Fieldbus systems such as FOUNDATION Fieldbus, PROFIBUS and/or HART are suitable protocols for the field devices to communicate with the higher-level control system or controller. Linking Devices may represent the appropriate components for the FOUNDATION Fieldbus. Appropriate components for PROFIBUS are provided by remote I/Os (remote input and output units).

DE 103 57 276 A1 discloses a system and a method for directed provision and installation of device-specific functionalities and/or information for field devices which are arranged in a distributed automation system, in which a device-specific component is provided for a higher-level controller and interacts with at least two functional units which are linked to it, such as documentation, DD (Device Description), DTM (Device Type Manager) etc. These device-specific components have means which automatically provide and install device-specific functionalities and/or information, stored in the functional units, for the field devices. This considerably simplifies the installation and configuration processes for commissioning the field device in the system. This is because this technical solution makes it possible to carry out an automatic installation process once the field device has been connected to the system.

However, this technical solution has the disadvantage that it is necessary to provide all the possible device-specific functionalities and/or information for field devices which can be connected to the system in a library, preferably in the higher-level controller. This means that continuous library updates are required in order to keep it completely up to date all the time.

### SUMMARY

A method and a system are disclosed for directed provision and installation of device-specific functionalities and/or information for field devices which are arranged in a distributed system, which involves little update effort and nevertheless allows simple installation of field devices in the system.

A method is disclosed for directed provision and installation of device-specific functionalities and/or information for field devices which are arranged in a distributed system, in particular in a distributed automation system, wherein in a first step, a field device to be connected to the system is supplied with basic functionalities and/or basic information (3) for operation of the field device in the system, bypassing a higher-level controller for the system, after which in a second step, the higher-level controller automatically installs further required upgrade functionalities and/or upgrade information in order to produce the full functional scope of the field device, using the existing basic functionalities and/or basic information.

A distributed system is disclosed, in particular a distributed automation system, for directed provision and installation of device-specific functionalities and/or information for field devices to be integrated in it, wherein a field device to be connected to the system is equipped with basic functionalities and/or basic information for operation of the field device in the system, bypassing a higher-level controller for the system, and wherein upgrade functionalities and/or upgrade information which are or is required to produce the full functional scope of the field device are/is installed automatically by the higher-level controller using the existing basic functionalities and/or basic information.

In another aspect, a firmware memory medium associated with a field device is disclosed, arranged in a distributed system for receiving a computer-language based basic functionalities and/or basic information based on a method for directed provision and installation of device-specific functionalities and/or information. The method comprises: in a first step, a field device to be connected to the system is supplied with basic functionalities and/or basic information for operation of the field device in the system, bypassing a higher-level controller for the system; and in a second step, the higher-level controller automatically installs further required upgrade functionalities and/or upgrade information in order to produce the full functional scope of the field device, using the existing basic functionalities and/or basic information.

### BRIEF DESCRIPTION OF THE DRAWING

Further measures as an improvement to the disclosure will be described in more detail in the following text together with the description of one exemplary exemplary embodiment of the disclosure and with reference to a single FIGURE. The FIGURE shows a schematic illustration of an exemplary system for directed provision and installation of device-specific functionalities and/or information for field devices integrated in it.

### DETAILED DESCRIPTION

The disclosure includes the method teaching that, in a first step, a field device to be connected to the system is initially supplied with basic functionalities and/or basic information for operation of the field device in the system, bypassing a higher-level controller for the system. Only in a second step does the higher-level controller automatically instal further required upgrade functionalities and/or upgrade information in order to produce the full functional scope of the field device, using the existing basic functionalities and/or basic information.

Only the rudimentary information which, for example, describes the device itself can be initially installed in order to configure the device for all the applications of a control system. An update for further functionalities can be carried out easily in this way, using this already existing basic information or these basic functionalities in the device. By way of example, standard functionalities based on conventional automation communication standards, such as fieldbus, can be combined with additional functionalities for one type of field device.

In order to ensure backward compatibility for the installation process with previous versions, it is proposed that available additional upgrade functionalities and/or upgrade information for a field device either replace and/or replaces the previously installed basic functionalities and/or basic information or additionally supplement them or it. This therefore also allows the basic functionalities and/or basic functions to be updated in a simple manner by reading in additional upgrade functionalities and/or upgrade functions.

In order to define relevant additional upgrade functionalities and/or upgrade information for a field device which is being newly installed in the system, a further measure, as an improvement to the disclosure, proposes that once a new field device has been connected to the system, the identity of this field device is matched to the types of field devices stored in the higher-level controller. Once the matching process has been carried out, the higher-level controller is then able to identify relevant upgrade functionalities and/or upgrade information, and to make them available to the new field device.

Within the scope of the present disclosure, basic functionalities and/or basic information for operation of the field device may comprise a communication-specific device description (DD), a capability file (CFF) and/or a device type manager (DTM). These basic functionalities and/or basic information make and/or makes it possible for the field device at least to start operating with the system. In consequence, the field device therefore contains more than the normal amount of firmware loaded in it by the device manufacturer.

The communication-specific device description (DD) is created in a specific programming language, specifically the device description language (DDL). The device description (DD) allows any desired field device to be integrated in the configuration tool. The device description (DD) is supplemented by the capability file (CFF file) for fieldbus. This describes the resources implemented in the field device, for example the number of functional blocks, execution times, etc. This allows off-line configuration of the field device and of the system.

A device type manager (DTM) is an active software component which offers the user complete access to the configuration of a field device, with an extensive graphics user interface. In this case, the graphics user interface for a device is always the same, irrespective of the configuration tool being used in the system. The device type manager (DTM) is normally supplied by the field device manufacturer, to be precise on a memory medium which is also supplied, such as CD-ROM.

The additional upgrade functionalities and/or upgrade information which are and/or is made available to a new field device in the second step comprise and/or comprises means for configuration and/or diagnosis. The configuration is embodied by the device description, and upload/download parameters, real-time asset management, electronic documentation and the like can be provided.

These and other upgrade functionalities and/or this and other upgrade information relating to various types of field devices are and/or is preferably stored within a device type library associated with the higher-level controller. This data is therefore available at a central point, and can thus easily be updated.

The FIGURE shows a schematic illustration of an exemplary system for directed provision and installation of device-specific functionalities and/or information for field devices integrated in it.

As shown in the FIGURE, an example of a field device 1 is a component of an exemplary distributed automation system. The field device 1, a valve driven by an electric motor for a pipeline system, is equipped by the device manufacturer with firmware which is stored in an integrated electronic control unit in order to operate the electric-motor drive that is integrated in the field device 1.

In order to connect the field device 1 to the system, it is first of all supplied directly, that is to say bypassing a higher-level controller 2, with basic functionalities and/or basic information 3. These basic functionalities is and/or this basic information 3 represent and/or represents a device description (DD) and allow and/or allows the field device 1 to be operated within the system. The various terminals 1 in this system communicate with the higher-level controller 2 by means of a bus system, in this case a FOUNDATION Fieldbus.

Once a new field device 1 has been connected to the system, the identity of this field device 1 is matched to the types of field devices 1 stored in the higher-level controller 2. This matching process results in the definition of any additional required upgrade functionalities and/or upgrade information 4 for the field device 1 that has been identified in this way. The required upgrade functionalities and/or upgrade information 4 for production of the full functional scope of the field device 1 are automatically installed in a second step, by transmission from the higher-level controller 2, using the already existing basic functionalities and/or basic information 3 in the field device 1.

The additional upgrade functionalities and/or upgrade information 4 comprise and/or comprises software means for configuration and diagnosis of the field device 1. The wide range of upgrade functionalities and/or upgrade information 4 for various types of field devices 1 is stored within a device type library 5 in the higher-level controller 2, where it is kept updated centrally.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

### LIST OF REFERENCE SYMBOLS

1 Field device
2 Higher-level controller
3 Basic functionalities and/or basic information
4 Upgrade functionalities and/or upgrade information
5 Device type library

What is claimed is:

1. A method for directed provision and installation of device-specific functionalities and/or information for field devices which are arranged in a distributed system, or in a distributed automation system,
the method comprising:
in a first step, a field device to be connected to the system is supplied with basic functionalities and/or basic information (3) for operation of the field device in the system, bypassing a higher-level controller for the system; and
in a second step, the higher-level controller automatically installs further required upgrade functionalities and/or upgrade information in order to produce the full functional scope of the field device, using the existing basic functionalities and/or basic information.

2. The method as claimed in claim 1,
wherein
available additional upgrade functionalities and/or upgrade information for a field device either replace and/or replaces the previously installed basic functionalities and/or basic information or additionally supplement them or it in order to ensure backward compatibility.

3. The method as claimed in claim 1,
wherein,
once a new field device has been connected to the system, the identity of this field device is matched to the types of field devices stored in the higher-level controller in order to determine the additional upgrade functionalities and/or upgrade information for the identified field device.

4. A distributed system, in particular a distributed automation system, for directed provision and installation of device-specific functionalities and/or information for field devices to be integrated in it,
wherein
a field device to be connected to the system is equipped with basic functionalities and/or basic information for operation of the field device in the system, bypassing a higher-level controller for the system, and wherein
upgrade functionalities and/or upgrade information which are or is required to produce the full functional scope of the field device are/is installed automatically by the higher-level controller using the existing basic functionalities and/or basic information.

5. The distributed system as claimed in claim 4, wherein the basic functionalities and/or basic information for operation of the field device comprise and/or comprises a communication-specific device description, a capability file and/or a device type manager.

6. The distributed system as claimed in claim 4, wherein the additional upgrade functionalities and/or upgrade information for the field device comprise and/or comprises means for configuration and diagnosis.

7. The distributed system as claimed in claim 4, wherein the upgrade functionalities and/or upgrade information for various types of field devices are and/or is stored within a device type library in the higher-level controller.

8. The distributed system as claimed in claim 4, wherein the communication between the various field devices in the system and the higher-level controller takes place via a bus system, comprising FOUNDATION Fieldbus, PROFIBUS and HART.

9. A firmware memory medium associated with a field device arranged in a distributed system for receiving a computer-language based basic functionalities and/or basic information based on a method for directed provision and installation of device-specific functionalities and/or information, the method comprising:
in a first step, a field device to be connected to the system is supplied with basic functionalities and/or basic information for operation of the field device in the system, bypassing a higher-level controller for the system; and
in a second step, the higher-level controller automatically installs further required upgrade functionalities and/or upgrade information in order to produce the full functional scope of the field device, using the existing basic functionalities and/or basic information.

10. The medium as claimed in claim 9,
wherein
available additional upgrade functionalities and/or upgrade information for a field device either replace and/or replaces the previously installed basic functionalities and/or basic information or additionally supplement them or it in order to ensure backward compatibility.

11. The medium as claimed in claim 9,
wherein,
once a new field device has been connected to the system, the identity of this field device is matched to the types of field devices stored in the higher-level controller in order to determine the additional upgrade functionalities and/or upgrade information for the identified field device.
